(19) United States
(12) Patent Application Publication
(10) Pub. No.: US 2005/0105438 A1
(43) Pub. Date: May 19, 2005

(54) Optical information recording method and optical information recording apparatus

(76) Inventors: Eiko Hibino, Kanagawa (JP); Kazunori Ito, Kanagawa (JP); Makoto Harigaya, Kanagawa (JP); Hiroshi Miura, Kanagawa (JP)

Correspondence Address: DICKSTEIN SHAPIRO MORIN & OSHINSKY LLP, 2101 L Street, NW, Washington, DC, 20037, US

(21) Appl. No.: 10/916,516

(22) Filed: Aug. 12, 2004

(30) Foreign Application Priority Data
Aug. 18, 2003 (JP) NO. 2003-294100

(51) Int. Cl. G11B 3/00

(52) U.S. Cl. 369/59.12; 369/59.11

(57) ABSTRACT

Optical information recording is achieved at high speed such as sixthfold to eightfold speed of DVD while suppressing jitter by a high-speed recording strategy such as a 2T period strategy, by once reducing the optical power of the optical beam used for optical recording, when starting recording of an amorphous mark pattern after the step of forming a crystalline space region but before the step of irradiating the optical beam with a peak power level for the mark formation, such that the optical power of the optical beam is reduced below the erasing optical power used for forming the crystalline space region.

### CROSS-REFERENCE TO RELATED APPLICATIONS

The present invention is based on Japanese priority patent application 2003-294100 filed on Aug. 18, 2003, the entire contents of which are incorporated herein as reference.

### BACKGROUND OF THE INVENTION

The present invention generally relates to optical recording of information and more particularly to optical information recording method and optical information recording apparatus suitable for high-speed optical recording of information on an optical information recording medium, particularly an optical information recording medium of phase change type such as CD-RW, DVD-RAM, DVD-RW, DVD+RW, and the like.

Recently, there is a growing demand of high-speed recoding in the art of optical recording that uses an optical information recording medium. In the case of optical recording that uses a disk-shaped optical information recording medium, increase of recording speed and playback speed is achieved by increasing the rotational speed of the disk.

Among various optical disks, the optical information recording disk of the type in which optical recording of information is made solely by the modulation of intensity of the optical beam irradiated upon the disk surface is used extensively, in view of the simple construction of the recording mechanism leading to low cost for the recording medium and also for the recording apparatus, and further in view of high compatibility with read-only apparatuses as a result of use of the intensity modulated optical beam also at the time of playback of the information. Thus, the optical recording medium of this type is exposed to particularly stringent demand of higher recording density and higher recording speed in view of the increase of the amount of information to be recorded on such a recording medium.

With regard to the technology of such optical disks, current trend uses a disk having a recording layer of a phase change material, in view of the possibility of rewriting information repeatedly over a large number of times.

In such an optical disk that uses a phase change material, recording of information is made by creating a quenched state and annealed state in the recording layer by way of intensity modulation of the optical beam irradiated upon the optical disk. In the quenched state, the material forming the recording layer becomes amorphous while in the annealed state, the recording layer becomes crystalline. Thereby, optical recording of information is achieved on the optical disk by using the difference of optical property between the amorphous state and the crystalline state.

Thus, in the optical recording disk of the phase change type, recording and erasing of information is achieved by heating the recording layer formed on a substrate of the optical disk by irradiating the recording layer with a laser beam such that the material forming the recording layer undergoes a phase change between the crystalline state and the amorphous state. Associated with this change of phase of the recording layer, the reflectivity of the recording layer is changed. Normally, the unrecorded state of the recording layer is provided by the crystalline phase or state having high reflectivity, and recording is made by forming a recording mark of amorphous phase or state having low reflectivity with a space of crystalline phase having high reflectivity formed between the recording marks.

Because the recording is thus achieved by a complex process of “quenching” and “annealing” of the recording layer, it has been practiced to achieve the desired high-speed recording by using the known process called pulse dividing process, wherein the recording is achieved by irradiating a recording optical beam having the intensity thereof modulated to take one of three optical power values.

For the recording waveform pattern (recording strategy) used for recording data on an optical disk repeatedly in the form of marks and spaces, it is known to use the one shown in FIG. 7, wherein it should be noted that the waveform pattern of FIG. 7 has been used in the art of DVD+RW, and the like.

Referring to FIG. 7, the mark provided by the amorphous state of the recording layer is formed by the repeated and alternate radiation of a peak power optical pulse having a peak optical power level (Pw=Pp) and a bias power optical pulse (Pb) having a bias optical power level. Further, the space region provided by the crystalline state of the recording layer is formed by irradiating an erase power optical beam (Pe) having an intermediate optical power level of the peak optical power level and the bias optical power level continuously. Alternately, the space region may be formed by irradiating an erase optical beam in the form of binary optical pulses.

Thus, upon irradiation of a recording optical pulse train including peak power optical pulses and bias power optical pulses, the recording layer of the optical disk undergoes melting and quenching alternately and repeatedly, and there is formed a recording mark of amorphous state in the recording layer as a result.

In the case an erasing optical beam of erasing optical power is irradiated, on the other hand, the recording layer undergoes gradual cooling after melting or annealing while maintaining the solid phase, leading to crystallization in the recording layer, and there is formed a space by the crystalline state of the recording layer.

The pulse train that includes the peak power optical pulse and the bias power optical pulse is generally formed of a lead pulse, an intermediate pulse and a tail pulse, and recording of the shortest 3T mark is achieved by using only the lead pulse and the tail pulse, while the intermediate pulse is used in addition to the lead pulse and the tail pulse at the time of recording the mark of 4T or longer. It should be noted that the intermediate pulse is called also a multi pulse and the intermediate pulse is used to increase the mark length by adding one such intermediate pulse when increasing the mark length by 1T. Thus, the number of the pulses in the pulse train for a mark having the mark length of nT becomes (n−1).

At the time of high speed recording such as the case of carrying out recording with a speed exceeding the quadruple speed of DVD, on the other hand, it should be noted that the fundamental clock period T is reduced and there is caused an increase of load in the driving unit that drives the optical source. Further, in the case of irradiating the pulse train of the 1T interval as shown in FIG. 7, both the heating time and the cooling time become reduced when the clock period T is reduced, and there arises a problem in that the amorphous mark having a sufficient size is not formed.

In order to avoid this problem, there has been made various proposals (reference should be made to Patent References 1-3, for example) to secure sufficient time of heating and cooling for forming the amorphous mark of sufficient size, by reducing the number of the pulses used to form the amorphous mark (increase the pulse interval beyond 1T).

Further, with regard to the recording strategy of this type, there is a proposal in the Patent Reference 4 to modulate the signal pulse used for forming a single recording mark such that the signal pulse is formed of a pulse train including plural short pulses and such that the first pulse in the pulse train has an optimized pulse width larger than the pulse width of the pulses that follow the first pulse. With this, the problem of distortion of the recording mark to have a teardrop form is eliminated.

Further, erasing of information is achieved by irradiating an optical beam of the intermediate power continuously or intermittently in the form of pulses. Further, the reference teaches that the transition from the erasing level to the recording level may be caused by decreasing the optical power once below the erasing level.

Further, there is a proposal made in the Patent Reference 5, in view of the problem pertinent to the technology of the Patent Reference 4 that the durability of the recording medium is tend to be degraded because of the local increase of thermal stress caused by the increase of the pulse duration in the first high-power optical pulse in the optical pulse train used for forming the recording mark with improved recording characteristics, to disperse the energy used in the first optical pulse in such a manner that the total energy of the respective channel bits becomes generally equal to the case of the Patent Reference 4.

Thus, as shown in FIG. 8, the pulse train forming a mark is formed such that the proportion of the interval in which the pulse power is set to the high power level Pw (=Pp) with respect to the interval in which the pulse power is set to the bias power level Pb is set to be constant for each channel bit.

Further, an erasing optical beam having an erasing power level Pe intermediate of the high power level Pw and the bias power level Pb, is irradiated continuously to the recording layer immediately before the pulse train forming a mark, such that there is formed a space preceding the recording mark, wherein it should be noted that the optical power of the erasing optical beam is increased to a power level Pa slightly larger than the erasing power Pe in one or two channel bits immediately preceding the mark. Thereby, the shortage of energy at the head part of the pulse train is compensated for.

Further, in the embodiment of the Patent Reference 5, the ratio of the irradiation interval of the optical pulse Pw to that of the optical pulse Pb is held constant, wherein it should be noted that the power of the first pulse in the pulse train is set to the high power level Pw after holding at the bias power level Pb, while each of the pulses in the pulse train after the first pulse has a power level set first to the high power level Pw and then to the bias power level Pe.

According to the foregoing proposal of the Patent Reference 5, the thermal stress is reduced and the durability of the recording medium for repeated recording is improved.

According to the recording strategy shown in the Patent Reference 6, on the other hand, there is provided, in the mark having a length of 4T or more, an interval of holding the optical power to a low power level such as the bias power level before the first pulse of the pulse train forming a mark.

More specifically, the interval xT of the high power level and the interval yT of the low power level are set in the first optical pulse of the pulse train so as to satisfy the relationship 0.95≦x+0.7*y≦2.5, and the interval of the pulses following that first pulse is set to be equal to or larger than 0.5T but not exceeding 1.5T.

With this, it becomes possible to prevent the recrystallization, which tends to occur at the head part of the mark at the time of recording an amorphous mark in an optical disk of multilayer construction that includes two or more recording layers, even in such a case in which the thickness of the reflection layer is small or reflection layer is not provided and large cooling rate is not attainable.
Patent Reference 1 Japanese Laid Open Patent Application 2002-237051
Patent Reference 2 Japanese Laid Open Patent Application 2002-288837
Patent Reference 3 Japanese Laid Open Patent Application 2001-331936
Patent Reference 4 Japanese Patent 2,707,774
Patent Reference 5 Japanese Laid Open Patent Application 2002-288,830
Patent Reference 6 Japanese Laid Open Patent Application 2001-273638

In the case of the recording method that uses a recording strategy shown in the foregoing Patent References 1-3 in which the number of the optical pulses is reduced when forming an amorphous mark, there can arise a problem that the temperature of the recording layer may not become stationary when the optical pulse of the peak power level is irradiated for the formation of the next recording mark in the case the length of the space immediately before the mark is small.

It should be noted that this problem appears particularly conspicuous when the linear recording velocity is increased due to the reduced time for optical irradiation. As a result of this problem, there occurs a fluctuation in the mark leading edge position at the time the optical beam of the peak power level is irradiated for the next mark formation, and there arises the problem of increased jitter.

In more detail, the inventor of the present invention has encountered a problem in the investigation of high-speed recording conducted with the sixfold to eightfold recording speed of DVD in that it is difficult to reduce the jitter as compared with the case of recording with quadruple recording speed.

After detailed analysis of the cause of this problem of increase of jitter, it was discovered that the jitter of the mark leading edge is particularly deteriorated when the mark is the one formed after the space of 3T length as shown in FIG. 9. It should be noted that FIG. 9 shows the jitter of the mark leading edge formed after various space lengths for the case a mark and a space of 3T-14T lengths are recorded repeatedly for ten times with a random pattern by way of the EFM+ modulation process while using the eightfold recording speed.

Further, it was discovered that the overall jitter of the mark edge to the clock is 10.8%.

The reason that the jitter of the mark leading edge is thus deteriorated particularly in the recording mark formed immediately after the 3T space may be that the temperature does not reach a stationary state because of the small space length preceding the mark and there is caused a variation in the mark leading edge position. In the case of the high speed recording of sixfold to eightfold speed of DVD, in particular, formation of the space region has to be made also in short time and it is believed that this also contributes to the foregoing problem of increased jitter by failing to reach the stationary state.

Further, at the time of the high-speed recording, cooling rate of the optical information recording medium tends to become also insufficient. Thus, in the case of forming a pattern of [mark 1]-[space 1]-[mark 2], with the small length for the [space 1] as in the case of 3T, there can be a situation in which the trailing edge of the [mark 1] may undergo crystallization as a result of the irradiation of the optical beam with the peak power level made at the beginning. Thereby, the jitter is also increased.

Further, in the case of using the recording strategy of 2T period in which the number of the pulse is increased by one each time the mark length increases by 2T, there are two possibilities with regard to the number of the pulses for recording a mark having an even mark length such as 4T, 6T, 8T, . . . , the one using the pulse number of 2, 3, 4, . . . , respectively for the mark lengths of 4T, 6T, 8T, . . . , the other using the pulse number of 1, 2, 3, . . . , respectively for the mark lengths of 4T, 6T, 8T, . . . .

In the case of high speed recording that uses the eightfold recording speed, for example, the crystallization rate of the optical recording medium is also fast, and there is a possibility, when recording a 4T mark by using two optical pulses, that the leading edge of the mark is heated again by the irradiation of the second optical beam of the peak power level, resulting in a recrystallization in such a part. Thereby, the jitter of the recording mark is deteriorated.

FIG. 3C shows the playback signal waveform obtained for such a case in which a recording mark is formed by the recording pulse train shown in FIG. 3A. This playback signal indicates that the recording mark has the shape of FIG. 3E in which the leading edge part of the mark undergoes shrinkage as a result of the recrystallization taking place in such a part.

In order to avoid this problem, one may tend to form such a 4T mark by using a single optical pulse. However, it is difficult to achieve overall balance by a single optical pulse, and it is difficult to achieve satisfactory recording with a random pattern.

### SUMMARY OF THE INVENTION

Accordingly, it is an object of the present invention to provide a method and apparatus enabling repetitive optical recording on an optical recording medium at high speed and with high quality at the time of high-speed recording mode, while suppressing the jitter at the same time.

Another object of the present invention is to provide an optical information recording method for recording information on an optical information recording medium by a mark length recording method according to a recording strategy in which a recording mark is formed on said optical information recording method with a mark length corresponding to a duration nT (n: natural number; T: fundamental clock period), said recording strategy comprising the steps of:
forming a mark pattern of amorphous state having a mark length corresponding to a duration nT in a recording layer of said optical information recording medium by irradiating a surface of said optical information recording medium with an optical beam in the form of plural optical pulses with an integer number equal to or less than n/2, said optical pulses including a repetition of a peak power optical pulse having a first, relatively high optical power, and a bias optical pulse having a second, relatively low optical power; and
forming a space region of crystalline state having a space length corresponding to a duration nT adjacent to said amorphous mark pattern by irradiating said surface of said optical information recording medium with said optical beam as an erasing optical beam with an intermediate optical power intermediate of said first optical power and said second optical power,
wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

Another object of the present invention is to provide an information recording apparatus for recording information on an optical information recording medium according to a mark length recording method, comprising:
a rotating mechanism rotating said optical information recording medium;
a laser source producing an optical beam such that said optical beam irradiates a surface of said optical information recording medium;
a driver circuit driving said laser source; and
an optical emission controller holding a recording strategy with regard to optical emission waveform of said optical beam produced by said laser source, said optical emission controller controlling said driver circuit according to said recording strategy,
said recording strategy comprising the steps of:
forming a mark pattern of amorphous state having a mark length corresponding to a duration nT (n: integer; T: period of a fundamental clock) in a recording layer of said optical information recording medium by irradiating said surface of said optical information recording medium with said optical beam in the form of plural optical pulses with an integer number equal to or smaller than n/2, said optical pulses including a repetition of a peak power optical pulse having a first, relatively high optical power and a bias optical pulse having a second, relatively low optical power; and
forming a space region of crystalline state having a space length corresponding to a duration nT in said recording layer adjacent to said amorphous mark pattern by irradiating said optical beam as an erasing optical beam with an intermediate optical power intermediate of said first optical power and said second optical power,
wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

### BRIEF DESCRIPTION OF THE DRAWINGS

FIG. 1 is a basic cross-sectional view diagram showing an example of a layered construction of an optical information recording medium according to an embodiment of the present invention;

FIG. 2 is a waveform diagram showing a recording strategy according to an embodiment of the present invention;

FIGS. 3A-3F are diagrams showing examples of a recording signal, playback signal and a mark pattern shape before and after the improvement of the present invention;

FIG. 4 is a schematic block diagram showing the construction of a control system of the optical information recording apparatus of the present invention;

FIG. 5 is a diagram showing the result of measurement with regard to the dependence of preceding space in Example 1 of the present invention;

FIG. 6 is a characteristic diagram showing the result of measurement on the dependence of preceding space in Example 4 of the present invention;

FIG. 7 is a waveform diagram showing an example of the recording strategy for 1T period;

FIG. 8 is a waveform diagram showing an example of the recording strategy shown in Patent Reference 5;

FIG. 9 is a characteristic diagram showing the result of measurement result on the dependence of preceding space for a conventional case;

FIG. 10 is a diagram showing the recording mark according to an example of the present invention in the form of table;

FIG. 11 is a diagram showing the recording mark according to another example of the present invention in the form of table;

FIG. 12 is a diagram showing the recording mark according to another example of the present invention in the form of table.

### DETAILED DESCRIPTION OF PREFERRED EMBODIMENTS

[Overview of the Invention]

According to a first aspect of the present invention, there is provided an optical information recording method for recording information on an optical information recording medium by a mark length recording method according to a recording strategy in which a recording mark is formed on said optical information recording method with a mark length corresponding to a duration nT (n: integer; T: fundamental clock period), said recording strategy comprising the steps of: forming a mark pattern of amorphous state having a mark length corresponding to a duration nT in a recording layer of said optical information recording medium by irradiating a surface of said optical information recording medium with an optical beam in the form of plural optical pulses with an integer number equal to or less than n/2, said optical pulses including a repetition of a peak power optical pulse having a first, relatively high optical power, and a bias optical pulse having a second, relatively low optical power; and forming a space region of crystalline state having a space length corresponding to a duration nT adjacent to said amorphous mark pattern by irradiating said surface of said optical information recording medium with said optical beam as an erasing optical beam with an intermediate optical power intermediate of said first optical power and said second optical power, wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

By using such a strategy in the high-speed recording of an nT mark pattern that uses plural optical pulses with the number not exceeding n/2 as in the case of the recording strategy of the 2T period, such that the optical power of the laser beam is reduced once to the low power level below the erasing optical power at the time of the transition from the state of forming the crystalline space region of the smallest time length in the recording layer of the optical information recording medium to the state of forming the amorphous mark pattern in the recording layer, the temperature of the recording layer on the optical recording medium is reduced once to a generally common temperature after formation of the crystalline space region as a result of the use of the laser beam of low power level set lower than the erasing optical power, even in the case there is caused a variation of temperature in the recording layer immediately after the formation of the crystalline space region but before starting the recording of the amorphous recording mark, particularly in the case of the crystalline space region of the smallest length. Thereby, the temperature difference between different space regions is reduced, and nearly the same temperature condition is realized in the recording layer irrespective of the length of the crystalline space region when the laser beam is irradiated thereafter with the peak power level. Thus, the variation in the leading edge of the recording mark, and hence the jitter of the recording mark, is successfully suppressed.

Further, because there occurs cooling in the recording medium during the irradiation of the laser beam with the low power level, the transfer of heat to the trailing edge part of the preceding mark pattern is successfully suppressed even when formation of the current mark pattern is made by irradiating the laser beam with the peak power level, and the recrystallization of the recording layer at such a trailing edge part of the preceding mark pattern is successfully eliminated. With this, the jitter at the trailing edge of the mark pattern is also suppressed.

In addition, because of the decrease of the temperature at the leading edge part of the recording mark at the time of formation of the recording mark due to the decrease of the laser beam power to the low power level below the erasing optical power immediately before starting formation of the recording mark, the temperature in such a leading edge part of the recording mark does not increase excessively even when irradiation of the laser beam is made again with the peak optical power thereafter, and the recrystallization of such a leading edge part of the recording mark is successfully suppressed. Thereby, the jitter at the leading edge of the recording mark is also suppressed.

In this way, the present invention can successfully suppress the occurrence of jitter at the time of high-speed recording conducted by using the recording strategy for high-speed recording.

It should be noted that Patent References 4-6 also teach the technology of irradiating an optical beam with an optical power set to be lower than the erasing optical power before starting any irradiation of the laser beam with the peak power level for formation of the recording mark. However, the technology disclosed in these prior art references assumes the relatively slow speed recording of 1T period and focuses on the problem of disk characteristics or thermal stress. There is no disclosure or suggestion in these prior art references about the subject matter dealt with the present invention, such as the effect of the short space region on the jitter of the recording mark formed subsequently to the foregoing short space region, the thermal effect of the very first optical irradiation made with the peak optical power for forming a recording mark, on the trailing edge of the preceding recording mark exerted via the preceding short space region, or the thermal effect of the second optical irradiation made with the peak optical power at the time of formation of the recording mark made with the peak optical power on the leading edge part of the same recording mark formed by the first optical irradiation also with the peak optical power, all under the condition that the recording strategy for high-speed recording is used.

In a preferred embodiment of the present invention, there is provided an optical information recording method as set forth above wherein said crystalline space region of shortest length has a length corresponding to duration 3T. With this, the present invention can be advantageously applied to the EFM modulation method used in the technology of CD-RW or to the EFM+ modulation method used in the technology of DVD±RW.

In a further preferred embodiment of the present invention, there is provided an optical information recording method as set forth above wherein said optical beam is reduced to said low power level at the time of transition from said step of forming said crystalline space region to said state of forming said amorphous recording mark pattern, irrespective of said length of said crystalline space region. By applying said recording strategy to all the crystalline space regions of various lengths, it becomes possible to use the recording strategy to all the mark lengths commonly, and the application of the invention is facilitated substantially.

In a further preferred embodiment of the present invention, there is provided an optical information recording method as set forth above wherein said low power level of said optical beam set equal to a bias optical power. While it is possible to cut off the optical power entirely at the time of reducing the optical power of the optical beam to said low power level, it is preferable to set the low power level to be equal to the foregoing bias optical power in view of increasing the optical power of the optical beam quickly to the peak optical power used for formation of the mark pattern.

In another preferred embodiment of the present invention, there is provided an optical information recording method as set forth above, wherein the duration in which said optical power of said optical beam is reduced to said low power level is set shorter than said fundamental clock period T. By restricting the duration or interval of the low power level to be equal to or smaller than the fundamental clock period T, it becomes possible to eliminate the problem of the recording mark not being erased completely upon overwriting, or the like.

In a further preferred embodiment of the present invention, there is provided an optical information recording method as set forth above, wherein a power level of said erasing optical beam used for forming said crystalline space region of shortest length is set to be lower than a power level of said erasing optical beam used at the time of forming a longer crystalline space region. It should be noted that the reason that the temperature of the recording layer does not easily reach a stationary state in the shortest crystalline space region at the time of high-speed recording is attributed to the insufficient cooling rate of the optical information recording medium. Thus, by reducing the optical power of the erasing optical beam used for forming the foregoing shortest crystalline space region as compared with the case of forming other, longer crystalline space regions, this problem of insufficient cooling rate of the recording medium is successfully avoided.

In a further preferred embodiment of the present invention, there is provided an optical information recording method as set forth above, wherein the duration of optical irradiation of the first optical pulse of said plural optical pulses irradiated for forming said amorphous mark pattern with said first optical power after said shortest crystalline space region is made different with regard to the duration of optical irradiation of the first optical pulse of said plural optical pulses irradiated for forming said amorphous mark pattern with said first optical power after a crystalline space region or longer length. Such a change of irradiation duration of the first optical pulse of the peak power selectively in the case of forming an amorphous mark pattern after the crystalline space region of the shortest length as compared with other cases also contributes to the improvement of the jitter.

In a further preferred embodiment of the present invention, there is provided an optical information recording method as set forth above, wherein said optical information recording medium is an optical information recording medium of a phase change type. According to the present invention, the optical recording method can be applicable successfully to the high-speed optical information recording medium of the phase change type.

In a further preferred embodiment of the present invention, there is provided an optical information recording method as set forth above, wherein said optical information recording medium of phase change type comprises a lamination of at least a first protective layer, a recording layer, a second protective layer and a reflective layer formed on a substrate, and wherein said recording layer contains Sb and one or more elements selected from the group consisting of Ge, Ga, In, Zn, Mn, Sn, Ag, Mg, Ca, Ag, Bi, Se and Te. Thus, the optical information recording method of the present invention is applicable successfully to the high-speed optical information recording medium of phase change type.

In a further preferred embodiment of the present invention, there is provided an optical information recording method as set forth above, wherein said recording medium contains Sb with a concentration of 50-90 atomic %. Thus, the optical information recording method of the present invention is applicable especially to the high-speed optical information recording medium of phase change type.

In a further preferred embodiment of the present invention, there is provided an optical information recording method as set forth above, wherein said reflection layer comprises Ag or an Ag alloy. Thus, the optical information recording method of the present invention is applicable especially to the high-speed optical information recording medium of phase change type.

In a further preferred embodiment of the present invention, there is provided an optical information recording method as set forth above, wherein said first protective layer and said second protective layer comprises a mixture of ZnS and SiO₂. Thus, the optical information recording method of the present invention is applicable especially to the high-speed optical information recording medium of phase change type.

In a further preferred embodiment of the present invention, there is provided an optical information recording method as set forth above, wherein there is further provided a sulfuration prevention layer between said second protective layer and said reflection layer. Thus, the optical information recording method of the present invention is applicable especially to the high-speed optical information recording medium of phase change type.

In a further preferred embodiment of the present invention, there is provided an optical information recording method as set forth above, wherein said sulfuration prevention layer contains Si or SiC as a major component. Thus, the optical information recording method of the present invention is applicable especially to the high-speed optical information recording medium of phase change type.

In another aspect of the present invention, there is provided an information recording apparatus for recording information on an optical information recording medium according to a mark length recording method, comprising:
a rotating mechanism rotating said optical information recording medium;
a laser source producing an optical beam such that said optical beam irradiates a surface of said optical information recording medium;
a driver circuit driving said laser source; and
an optical emission controller holding a recording strategy with regard to optical emission waveform of said optical beam produced by said laser source, said optical emission controller controlling said driver circuit according to said recording strategy,
said recording strategy comprising the steps of:
forming a mark pattern of amorphous state having a mark length corresponding to a duration nT (n: integer; T: period of a fundamental clock) in a recording layer of said optical information recording medium by irradiating said surface of said optical information recording medium with said optical beam in the form of plural optical pulses with an integer number equal to or smaller than n/2, said optical pulses including a repetition of a peak power optical pulse having a first, relatively high optical power and a bias optical pulse having a second, relatively low optical power; and
forming a space region of crystalline state having a space length corresponding to a duration nT in said recording layer adjacent to said amorphous mark pattern by irradiating said optical beam as an erasing optical beam with an intermediate optical power intermediate of said first optical power and said second optical power,
wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

By using such a strategy in the high-speed recording of an nT mark pattern that uses plural optical pulses with the number not exceeding n/2 as in the case of the recording strategy of the 2T period, such that the optical power of the laser beam is reduced once to the low power level below the erasing optical power at the time of the transition from the state of forming the crystalline space region of the smallest time length in the recording layer of the optical information recording medium to the state of forming the amorphous mark pattern in the recording layer, the temperature of the recording layer on the optical recording medium is reduced once to a generally common temperature after formation of the crystalline space region as a result of the use of the laser beam of low power level set lower than the erasing optical power, even in the case there is caused a variation of temperature in the recording layer immediately after the formation of the crystalline space region but before starting the recording of the amorphous recording mark, particularly in the case of the crystalline space region of the smallest length. Thereby, the temperature difference between different space regions is reduced, and nearly the same temperature condition is realized in the recording layer irrespective of the length of the crystalline space region when the laser beam is irradiated thereafter with the peak power level. Thus, the variation in the leading edge of the recording mark, and hence the jitter of the recording mark, is successfully suppressed.

Further, because there occurs cooling in the recording medium during the irradiation of the laser beam with the low power level, the transfer of heat to the trailing edge part of the preceding mark pattern is successfully suppressed even when formation of the current mark pattern is made by irradiating the laser beam with the peak power level, and the recrystallization of the recording layer at such a trailing edge part of the preceding mark pattern is successfully eliminated. With this, the jitter at the trailing edge of the mark pattern is also suppressed.

In addition, because of the decrease of the temperature at the leading edge part of the recording mark at the time of formation of the recording mark due to the decrease of the laser beam power to the low power level below the erasing optical power immediately before starting formation of the recording mark, the temperature in such a leading edge part of the recording mark does not increase excessively even when irradiation of the laser beam is made again with the peak optical power thereafter, and the recrystallization of such a leading edge part of the recording mark is successfully suppressed. Thereby, the jitter at the leading edge of the recording mark is also suppressed.

In this way, the present invention can successfully suppress the occurrence of jitter at the time of high-speed recording conducted by using the recording strategy for high-speed recording.

In a preferred embodiment of the present invention, there is provided an optical information recording apparatus as set forth above, wherein said optical emission controller controls said driver circuit such that said crystalline space region of shortest length has a length corresponding to duration 3T. With this, the present invention can be advantageously applied to the EFM modulation method used in the technology of CD-RW or to the EFM+ modulation method used in the technology of DVD±RW.

In a further preferred embodiment of the present invention, there is provided an optical information recording apparatus as set forth above wherein said optical emission controller controls said driver circuit such that said optical beam is reduced to said low power level at the time of transition from said step of forming said crystalline space region to said state of forming said amorphous recording mark pattern, irrespective of said length of said crystalline space region. By applying said recording strategy to all the crystalline space regions of various lengths, it becomes possible to use the recording strategy to all the mark lengths commonly, and the application of the invention is facilitated substantially.

In a further preferred embodiment of the present invention, there is provided an optical information recording apparatus as set forth above, wherein said optical emission controller controls said driver circuit such that said low power level of said optical beam set equal to a bias optical power. While it is possible to cut off the optical power entirely at the time of reducing the optical power of the optical beam to said low power level, it is preferable to set the low power level to be equal to the foregoing bias optical power in view of increasing the optical power of the optical beam quickly to the peak optical power used for formation of the mark pattern.

In another preferred embodiment of the present invention, there is provided an optical information recording apparatus as set forth above, wherein said optical emission controller controls said driver circuit such that the duration in which said optical power of said optical beam is reduced to said low power level is set shorter than said fundamental clock period T. By restricting the duration or interval of the low power level to be equal to or smaller than the fundamental clock period T, it becomes possible to eliminate the problem of the recording mark not being erased completely upon overwriting, or the like.

In a further preferred embodiment of the present invention, there is provided an optical information recording apparatus as set forth above, wherein said optical emission controller controls said driver circuit such that a power level of said erasing optical beam used for forming said crystalline space region of shortest length is set to be lower than a power level of said erasing optical beam used at the time of forming a longer crystalline space region. It should be noted that the reason that the temperature of the recording layer does not easily reach a stationary state in the shortest crystalline space region at the time of high-speed recording is attributed to the insufficient cooling rate of the optical information recording medium. Thus, by reducing the optical power of the erasing optical beam used for forming the foregoing shortest crystalline space region as compared with the case of forming other, longer crystalline space regions, this problem of insufficient cooling rate of the recording medium is successfully avoided.

In a further preferred embodiment of the present invention, there is provided an optical information recording apparatus as set forth above, wherein said optical emission controller controls said driver circuit such that the duration of optical irradiation of the first optical pulse of said plural optical pulses irradiated for forming said amorphous mark pattern with said first optical power after said shortest crystalline space region is made different with regard to the duration of optical irradiation of the first optical pulse of said plural optical pulses irradiated for forming said amorphous mark pattern with said first optical power after a crystalline space region or longer length. Such a change of irradiation duration of the first optical pulse of the peak power selectively in the case of forming an amorphous mark pattern after the crystalline space region of the shortest length as compared with other cases also contributes to the improvement of the jitter.

In a further preferred embodiment of the present invention, there is provided an optical information recording apparatus as set forth above wherein said optical information recording medium is an optical information recording medium of a phase change type. According to the present invention, the optical recording method can be applicable successfully to the high-speed optical information recording medium of the phase change type.

By using such a strategy of the present invention in the high-speed recording of an nT mark pattern that uses plural optical pulses with the number not exceeding n/2 as in the case of the recording strategy of the 2T period, it becomes possible to suppress the degradation of jitter characteristics even under the mode of high-speed recording, and it becomes possible to achieve excellent recording repeatedly.

The present invention can be advantageously applied to the EFM modulation method used in the technology of CD-RW or to the EFM+ modulation method used in the technology of DVD±RW.

By applying the foregoing recording strategy to all the crystalline space regions of various lengths, it becomes possible to use the recording strategy to all the mark lengths commonly, and the application of the invention is facilitated substantially.

Further, according to the present invention, it becomes possible to increase the optical power of the optical beam quickly to the peak optical power used for formation of the mark pattern.

By restricting the duration or interval of the low power level to be equal to or smaller than the fundamental clock period T, it becomes possible to eliminate the problem of the recording mark not being erased completely upon overwriting, or the like.

It should be noted that the reason that the temperature of the recording layer does not easily reach a stationary state in the shortest crystalline space region at the time of high-speed recording is attributed to the insufficient cooling rate of the optical information recording medium. Thus, by reducing the optical power of the erasing optical beam used for forming the foregoing shortest crystalline space region as compared with the case of forming other, longer crystalline space regions, this problem of insufficient cooling rate of the recording medium is successfully avoided and it becomes possible to reduce the jitter effectively.

By changing the irradiation duration of the first optical pulse of the peak power selectively in the case of forming an amorphous mark pattern after the crystalline space region of the shortest length as compared with other cases, the problem of jitter is improved effectively.

The present invention can be applicable effectively to the high-speed optical information recording medium of the phase change type.

### EMBODIMENT

Hereinafter, the present invention will be explained for a best mode by referring to the drawings.

The embodiment of the present invention is applicable to an optical information recording method and optical information recording apparatus (including optical information playback apparatus) that records information on an optical information recording apparatus capable of recording, erasing or rewriting information by way of intensity modulation of an irradiated optical beam, particularly an optical information recording medium of the phase change type, with high speed such as sixfold to eightfold speed of a DVD.

[Optical Information Recording Medium]

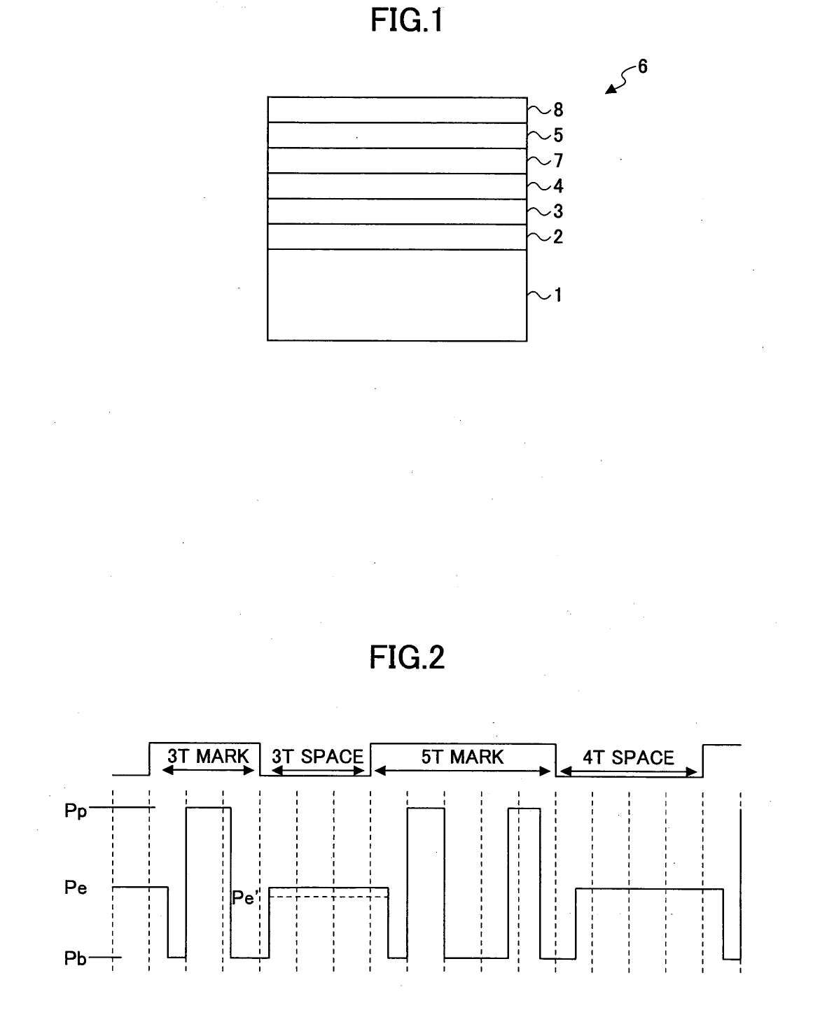

First, an example of the optical information recording medium of the phase change type of high-speed specification designed for the specification of DVD will be explained with reference to FIG. 1.

In the present embodiment, an optical information recording medium 6 of the phase change type will be treated, wherein the optical information recording medium comprises a transparent substrate formed with a guiding groove and carries thereon a lamination of at least a first protective layer 2, a recording layer 3, a second protective layer 4 and a reflective layer 5.

Preferably, the transparent substrate 1 is formed of polycarbonate in view of endurance to heat, endurance to shock and low water absorption, wherein it is preferable that the substrate has the refractive index of 1.5-1.65. When the refractive index exceeds the foregoing range, there occurs overall decrease of reflectivity of the disk, while when the refractive index is smaller than the foregoing range, there is caused the problem of insufficient modulation due to the increase of the reflectivity.

With regard to the substrate thickness, it is preferable that the range of 0.59-0.62 mm is preferable. When the thickness exceeds the foregoing range, there would be caused the problem of focusing when an optical beam is irradiated on the disk surface by an optical pickup. Further, when the thickness is smaller than the foregoing range, there may be caused the problem of unstable rotational speed due to the difficulty of achieving secure clamping in the recording and playback apparatus. Further, there may be caused the problem of the signal strength changing in the circumferential direction in the case there is a variation of substrate thickness in the circumferential direction beyond the foregoing range.

The recording layer 3 uses a material containing Sb and at least one element selected from the group consisted of Ge, Ga, In, Zn, Mn, Sn, Ag, Mg, Ca, Ag, Bi, Se and Te. By using Sb as the base element and combining therewith an element such that the element forms a binary eutectic system having an eutectic point of about 600° C. or less or a solid solution having a melting point of about 600° C. or less, it becomes possible to form a recording layer 3 suitable for carrying out repetitive recording in the form of amorphous region and crystalline region. Thereby, by choosing the element to be combined with Sb and by adjusting the amount thereof, the characteristics of the optical information recording disk such as crystallization rate, recording characteristics, data retention characteristics, easiness of initialization, and the like, are adjusted.

One or more elements can be combined with Sb, and the number of the elements combined with Sb may be increased according to the needs. Further, it is also possible to add a further element to the foregoing binary alloy or multicomponent alloy of Sb.

In the case of carrying out repetitive recording at high speed, it is necessary to crystallize the amorphous recording mark at high speed. Thus, in the case of carrying out recording at the speed of sixfold-eightfold speed of DVD as in the case of the present invention, it is preferable to set the Sb content of the recording layer 3 to be 50-90 atomic %, more preferably 60-80 atomic %.

When the Sb content is lower than the foregoing range, the crystallization rate becomes to small and the amorphous recording mark may not be erased completely at the time of the repetitive recording. This results in increase of jitter or error. When the Sb content is larger than the foregoing range, there arises a problem hat formation of the amorphous recording mark becomes difficult.

With regard to the thickness of the recording layer 3, it should be noted that the degree of modulation becomes small when the thickness is smaller than 8 nm. Further, there occurs degradation in the stability of the reflected optical beam used for reading of information. On the other hand, there arises the problem of increased jitter at the time of repetitive recording in the case the thickness of the recording layer 3 exceeds 22 nm. Thus, it is preferable to set the thickness of the recording layer 3 to be equal to or larger than 8 nm but not exceeding 22 nm. More preferably, the thickness of the recording layer 3 is set to the range of 11-16 nm for endurance to repetitive recording.

For the reflection layer 5, an alloy predominantly of Al has been used conventionally. It should be noted that Al has an advantageous feature of high reflectivity and high thermal conductivity. In addition, Al has another advantageous feature of stability against aging when used in the form of a disk.

In the case where the recording layer 3 has a large crystallization rate, on the other hand, there arises a problem, in the optical information recording disk using an Al alloy for the reflection layer 5, in that the recording mark tends to have an elongated shape and there can be cases in which recording with sufficient degree of modulation is difficult. When the crystallization rate is too large, it should be noted that recrystallization occurs extensively in the molten region at the time of the recording, leading to decrease of the amorphous mark region.

In order to reduce the recrystallization region, it is possible to employ a quench structure by reducing the thickness of the second protective layer 4. However, mere decrease of thickness of the second protective layer 4 results in the problem that the recording layer 3 is not sufficiently heated at the time of recording and the molten region is reduced. Thereby, although it may be possible to reduce the recrystallization region, size of the amorphous region formed as a result of the recording is reduced after all.

On the other hand, by using a metal having a refractive index represented as (n+ik) such that both n and k are smaller than those of Al in the wavelength of 650-670 nm for the reflection layer 5, the absorptance of the recording layer 3 is improved together with the degree of modulation. For such a metal in which both of n and k exceeding those of Al, it is possible to use any of Au, Ag, Cu or an alloy containing those as a major component. Here, it should be noted that “major component” is defined that the element is contained with a concentration of 90 atomic % or more, preferably 95 atomic % or more.

It should be noted that all of Au, Ag and Cu have a thermal conductivity larger than that of Al, and thus, the use thereof for the reflection layer 5 brings forth the effect of temperature increase of the recording layer 3 as a result of increase of the optical absorptance of the recording layer 3. At the same time, the cooling rate is increased, and thus, the area of the recrystallized region at the time of cooling is reduced, and it becomes possible to form the amorphous region with an area larger than the case of using the Al alloy.

The degree of modulation of the recording mark is determined by the degree of optical modulation and the size of the mark and takes a larger value when the degree of optical modulation is increased and the mark size is increased. Thus, by using such a reflection layer 5 at the time of carrying out high linear velocity recording by using a material of high crystallization rate for the recording layer 3, it becomes possible to form a large recording mark due to the large absorptance and large cooling rate. Further, in view of the large difference of reflectivity between the crystalline state and the amorphous state, it becomes possible to achieve recording with large degree of modulation.

Among the metals of Au, Ag, Cu and an alloy thereof, Ag and an Ag alloy are relatively low cost and have the advantageous feature of experiencing less oxidation as compared with the case of similarly low cost Cu or Cu alloy. Thus, the use of Ag or Ag alloy for the reflection layer 5 is thought advantageous for forming a medium having long time stability.

By setting the thickness of the reflection layer 5 to be 90 nm or more, transmission light through the film is almost eliminated and the efficiency of use of the light is improved substantially. Thus, in the present invention, the thickness of the reflection layer 5 is set to be 90 nm or more. Larger the thickness of the reflection layer 5, the faster the cooling rate. Thus, the use of thick reflection layer 5 is thought advantageous when using a material of large crystallization rate for the recording layer 3. On the other hand, when the thickness of the reflection layer 5 has exceeded 200 nm, there appears saturation in the cooling rate, and little change is noted in the recording characteristics when the thickness of the reflection layer 5 is increased beyond 200 nm. In view of excessive time needed for forming such a thick reflection layer, it is preferable to form the reflection layer 5 such that the thickness thereof does not exceed 200 nm.

In the case of using Ag or an Ag alloy for the reflection layer 5, it is necessary to provide a sulfuration prevention layer 7 at the time of using a material containing S for the second protective layer 4. It should be noted that the sulfuration prevention layer 7 is required to have the features such as it does not contain S, it does not allow passage of S, and the like.

The inventor of the present invention has made evaluation on the material suitable for the sulfuration prevention layer 7 with regard to recording characteristics or reliability of data retention by forming the sulfuration prevention layer 7 by using various oxide film or nitride film and discovered that SiC or Si, or a material containing one of these as the major component shows excellent performance for the sulfuration prevention layer 7. Here, it should be noted that “major component” means that SiC or Si component is contained in the material with a concentration of 90 mol % or more, preferably 95 mol % or more.

Preferably, the sulfuration prevention layer 7 has a thickness of 3-22 nm. By setting the thickness of the sulfuration prevention layer 7 to be 3 nm or more, it becomes possible to form the film with generally uniform thickness, which is essential for the function of sulfuration prevention film, by way of sputtering. When the thickness is smaller than the foregoing, there is caused a sharp increase of probability of forming localized defects. On the other hand, when the thickness of the layer 7 is larger than 22 nm, there occurs a decrease of reflectivity with increase of the film thickness. Further, because the growth rate of the sulfuration prevention layer 7 is generally identical with or smaller than that of the recording layer 3, there occurs a decrease of productivity when the thickness of the sulfuration prevention layer 7 is set larger than that of the recording layer 3. Thus, it is preferable that the thickness of the sulfuration prevention layer 7 does not exceed the thickness of the recording layer 3 in the maximum. Thus, the upper limit thickness of the sulfuration prevention layer 7 becomes 22 nm.

With regard to the first protective layer 2 and the second protective layer, a mixture of ZnS and SiO2 with a ratio of about 8:2 in view of the possibility of efficient use of the incident light by way of adjustment of the film thickness, in addition to the performance of the protective film of endurance to heat, high refractive index and high adiabaticity.

More specifically, the first protective layer 2 is formed to have the film thickness of 40-220 nm, more preferably 40-80 nm, in view of the reflectivity. Thus, an optimum film thickness is chosen form the foregoing range such that sufficient reflectivity and sufficient recording sensitivity are both attained. When the thickness is smaller than the foregoing range, endurance to heat is deteriorated and there is a possibility that the substrate undergoes severe damaging. Thereby, there is caused an increase of jitter when repetitive recording is conducted. When the thickness exceeds the foregoing range, on the other hand, the reflectivity tends to become excessive and there is caused decrease of recording sensitivity.

With regard to the second protective layer 4, the film thickness is set to fall in the range of 2-20 nm, more preferably 6-14 nm, mainly in view of the requirement of thermal conductivity. Because the second protective layer 4 is further covered by the reflection layer 5, the heat absorbed by the recording layer 3 is dissipated to the reflection layer 5 through the second protective layer 4. Thereby, cooling occurs in the recording layer 3.

Thus, when the thickness of the second protective layer 4 is too small, there is caused no sufficient temperature rise in the recording layer 3 because of excessive thermal dissipation, and there occurs a decrease of recording sensitivity. When the thickness of the second protective layer 4 is excessive, on the other hand, the cooling rate becomes too small and it becomes difficult to form the amorphous marks.

Thus, a layered structure is formed on the substrate 1 by forming thereon the first protective layer 2, the recording layer 3, the second protective layer 4, the sulfuration prevention layer 7 and the reflection layer 5 consecutively by sputtering. Further, an organic protective layer 8 is formed on the reflection layer 5 by spin coating.

In this state, or after carrying out a further bonding process, an initializing process is carried out to form the optical information recording medium 6. It should be noted that the bonding process is a process of bonding, upon the organic protective film 8, a plate of the size of the substrate with the same material of the substrate.

Further, it should be noted that the initialization process is the process of crystallizing the recording layer 3, which takes the amorphous phase in the as-formed state, by irradiating a laser beam of about 1-2 W shaped to have a size of 1× (several tens to several hundreds) μm.

[Optical Information Recording Method]

Next, optical information recording method used for recording optical information at high speed on the foregoing optical information recording medium 6 of high-speed recording specification will be explained particularly about the recording strategy thereof, with reference to FIG. 2.

In the description hereinafter, it is assumed that optical information is recorded on the optical information recording medium 6 according to the mark length modulation and mark interval modulation method that uses a PWM (Pulse Width Modulation) process.

In this recording method, information is recorded on the optical information recording medium 6 by controlling the length of the recording mark and the length of the space region existing between a pair of recording marks in terms of the unit length T set equal to the fundamental clock period T. By using the mark length modulation and mark interval modulation method noted above, it becomes possible to increase the recording density as compared with the case of the recording method that uses the mark position modulation, and thus, the mark length modulation and mark interval modulation is used extensively in the EFM modulation technology used in CDs and DD (Double Density) CDs or in the EFM+ technology used in DVDs.

In such a recording mark length and mark interval modulation method, it is important to control the recording mark length and also the length of the mark interval (referred to hereinafter as space length). Thus, in the mark length and mark interval modulation method, both the recording mark length and the space length are controlled to have a length corresponding to the duration nT where T is the period of the fundamental clock used for recoding and playback, while n is a natural number of 3 or more.

In the present embodiment hereinafter, it should be noted that the use of a trivalent recoding strategy that uses a peak power level Pp, an erasing power level Pe and a bias power level Pb is assumed wherein the recording strategy is optimized by reducing the number of the optical pulses for high speed recording such that there is caused sufficient heating and cooling in the recording medium at the time of recording of information.

More specifically, there is formed an amorphous recording mark of the mark length corresponding to the duration nT (n being a natural number) by irradiating plural optical pulses with an integer number equal to or less than n/2 in such a manner that the optical pulses comprise a repetition of the peak power level Pp and a bias power level Pb. Further, a crystalline space region having a length corresponding to the duration nT is formed adjacent to the amorphous mark pattern as a result of irradiation of an erasing optical beam having the erasing power level Pe.

Thus, in the case of forming the shortest recording mark pattern having the mark length 3T according to the EFM+ modulation, the 3T recording mark pattern is formed by a single pulse. If the shortest 3T mark pattern is formed by using two or more pulses, it becomes not possible to secure sufficient cooling duration between the pulses, and there occurs the problem of recrystallization at the leading edge of the mark as a result of irradiation of the later pulse, and the desired mark patter of the 3T length is not obtained.

In the case of the recording marks having the length of 4T ore more, it is possible to form the mark pattern by a single pulse similarly to the case of the 3T mark or by using two or more pulses. Thereby, the number of the pulses is determined primarily by the recording linear velocity. It is preferable to reduce the number of the pulses when the recording linear velocity is increased.

In the exemplar recording strategy shown in FIG. 2, it will be noted that the 3T mark pattern is formed by a single pulse, the 4T and 5T mark patterns are formed by two pulses. Similarly, the 6T and 7T mark patterns are formed by three pulses, although not illustrated). It should be noted that the recording strategy of FIG. 2 is a recording strategy of the 2T period.

Further, the optical information recording method of the present embodiment optimizes the recording strategy in view of the requirement of high-speed recording by modulating the optical power of the optical beam at the time of transition from the state of forming a crystalline space region to the state of forming an amorphous mark region, such that the optical power is once reduced to a low power level such as the bias power level Pb lower than the erasing power level Pe.

Thus, in the present embodiment, the optical beam is modulated with the bias power level Pb lower than the erasing power level Pe before commencing the irradiation of the first optical pulse of the peak power level Pp. By doing so, there occurs a decrease of temperature in the recording layer, and the temperature of the recording medium immediately after the crystalline space region is more or less initialized even when there are formed various crystalline space regions of various space lengths.

Thereby, the temperature immediately before irradiation of the optical pulse with the peak power level Pp becomes more or less the same after any of the crystalline space regions of various lengths, and the variation in the leading edge position of the recording mark pattern is suppressed effectively. With this, deterioration of jitter is suppressed effectively.

This recording strategy of the present embodiment of reducing the optical power of the optical beam once to the low power level such as Pb lower than the erasing power level Pe after a crystalline space region, is particularly effective in the case of forming a mark pattern after the crystalline space region of the shortest length of 3T in view of the tendency in the technology of high-speed optical recording that the temperature does not easily reach a stationary state in such a part immediately after the shortest 3T space region.

With regard to the erasing optical beam having the erasing power Pe, it is possible to irradiate the erasing optical power continuously. Alternatively, it is also possible to irradiate the erasing optical beam in the form of a binary state beam that changes the power level thereof within a range between the peak power level Pp and the bias power level Pb.

With regard to the foregoing low lower level, it is possible to chose the low power level equal to the off power level. On the other hand, in view of the easiness of increasing the optical power to the peak power level Pp in short time at the time of formation of the recording mark, it is preferable to set this low power level to be equal to the foregoing bias power level Pb as set forth in the present embodiment.

In addition to the foregoing advantageous feature of the present invention, it was discovered that the recording strategy of the present embodiment of reducing the optical power of the optical beam once to the low power level lower than the erasing power level Pe before irradiating the first optical pulse with the peak power level Pp for mark formation provides an additional beneficial effect that the jitter at the trailing edge of the immediately preceding mark is also improved.

This problem of jitter caused at the trailing edge of the preceding recording mark is believed to be caused because of the insufficient cooling rate of the optical recording medium 6. More specifically, in the case of recording a pattern such as [Mark 1]-[Space 1]-[Mark 2] at high speed, there can be a situation that a crystallization is induced at the trailing edge of the preceding recording mark region [Mark 1] on irradiation of the optical beam of the peak power level Pp used for formation of the current recording mark region [Mark 2] as a result of transfer of heat from the mark region [Mark 2] to the mark region [Mark 1] through the intervening crystalline space region [Space 1], provided that the recording is carried out at high speed and the crystalline space region [Space 1] has a short length.

By reducing the power of the optical beam to the foregoing low power level before irradiating the first optical beam with the peak power level Pp for the formation of the mark pattern [Mark 2], there occurs a cooling in the recording layer, and it is believed that this cooling has prevented the recrystallization of the recording layer at the trailing edge of the preceding recording mark pattern [Mark 1] by preventing the excessive temperature rise at such a trailing edge part of the mark pattern [Mark 1].

Further, in the case of conducting high-speed recording by using a 2T recording strategy in which the number of the pulses is increased by one each time the mark length is increased by 2T, there can be different patterns with regard to the number of the pulses for the recording marks of even number lengths 4T, 6T, 8T, . . . , the one variation uses the pulse number of 2, 3, 4, . . . respectively in correspondence to the recording lengths 4T, 6T, 8T, . . . , while the other variation uses the pulse number of 1, 2, 3, . . . respectively in correspondence to the recording lengths 4T, 6T, 8T, . . . . Further, there can be a pattern that uses two pulses for the mark lengths 4T and 6T and 3, 4, and 6 pulses respectively in the case the mark length is 8T, 10T and 14T.

In using such a recording strategy, there can be caused a problem, associated with the large cooling rate of the optical information recording medium 6 used high-speed recording such as the eightfold speed recording, in that the leading edge part of a recording mark undergoes crystallization in the case the recording mark is the one recorded with two pulses such as a 4T mark pattern, upon irradiation of the second optical pulse made with the peak power level Pp. Thereby, there occurs the problem of jitter at the leading edge of the recording mark.

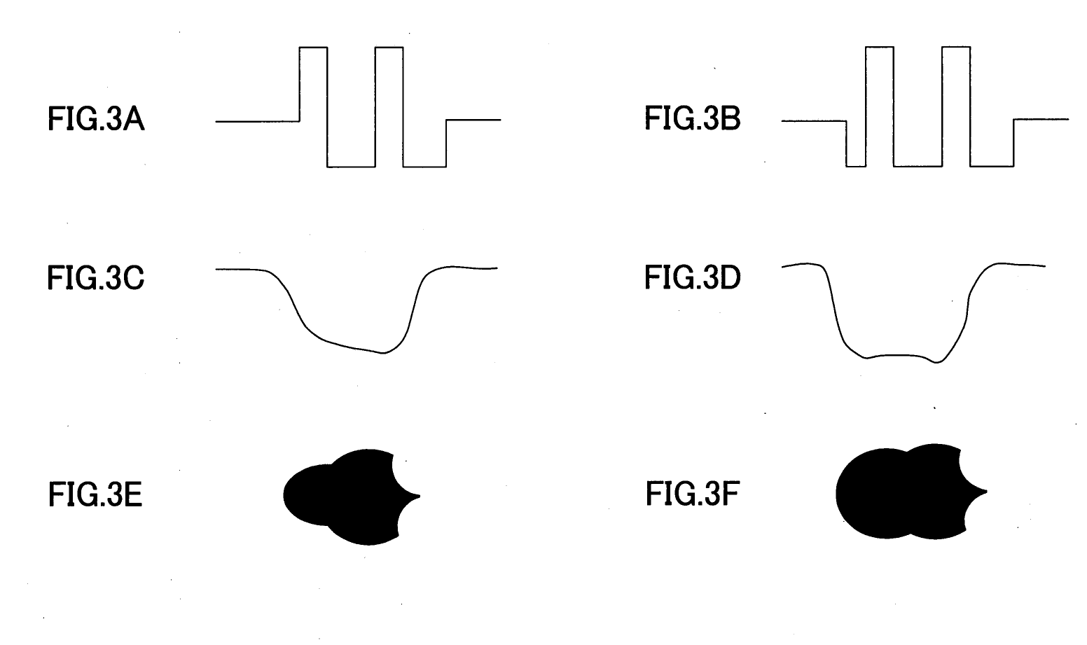

FIG. 3C shows the reproduced signal waveform obtained in such a situation.

From the waveform of FIG. 3C, it is inferred that the recording mark has experienced shrinkage at the leading edge part as a result of recrystallization as shown in FIG. 3E.

While this problem can be overcome if the 4T mark pattern can be formed by a single pulse, such formation of a long recording mark by a single optical pulse is difficult, particularly with regard to the overall mark pattern shape, and it is difficult to achieve satisfactory recording by using a random pattern.

On the other hand, in the case the 4T mark pattern is recorded with the two optical pulses in such a manner that the optical beam is modulated once to the foregoing low power level lower than the erasing power before irradiating the first optical pulse of the peak power level Pb for the formation of the recording mark pattern as in the case of the present embodiment (FIG. 3B), a reproduced signal shown in FIG. 3D is obtained, and remarkable improvement was observed for the jitter at the mark leading edge position.

From this reproduced signal waveform, it is inferred that the recording mark formed on the optical information recording medium 6 has a shape shown in FIG. 3F in which the recrystallization at the leading edge part of the recording mark pattern is successfully suppressed. It is believed that the result of FIG. 3F is obtained because the temperature at the leading edge part of the recording mark is reduced at the time the recording mark is formed by the first optical pulse of the peak power level Pp in the strategy of FIG. 3B as compared with the case of using the strategy of FIG. 3A, and thus, there occurs no excessive temperature rise causing the recrystallization even when the irradiation of the second optical pulse is made with the peak power level Pp.

While it is possible to apply the recording strategy of FIG. 3B selectively to the case of forming a mark pattern after the shortest crystalline space region of the 3T length, it is more practical to use the recording strategy of FIG. 3B of modulating the optical power of the optical beam once to the bias power level Pb or less immediately after forming the crystalline space region, irrespective of the length of the crystalline space region. With this, the recording strategy can be used commonly for all the mark lengths.

It is preferable that the duration in which the optical power of the optical beam is held to the foregoing low power level such as the bias power level Pb lower than the erasing power level Pe at the time of transition from the mode of forming the crystalline space region to the mode of forming the amorphous mark region is set to be 1T or less. When the duration exceeds the foregoing interval of 1T, there can be a possibility that the recording mark is not erased completely at the time of overwriting an existing mark with a new mark.

Further, it should be noted that the irradiation condition of the first optical pulse at the time of forming an amorphous mark pattern of the mark length of 4T or more is important for the precise formation of the mark leading edge, and thus, the duration of the optical pulse of the peak power Pp is set to fall in the range of 0.5T-2.0T, more preferably to the range of 0.7T-1.6T, when recording is made with the eightfold speed of DVD.

When the irradiation duration is shorter than the foregoing range, there is a tendency that the optical power becomes insufficient partly in view of the delay of laser response, and sufficient molten region is not secured. When the duration exceeds the foregoing range, on the other hand, there tends to be caused recrystallization at the leading edge part of the recording mark, and an amorphous recording mark of sufficient size cannot be formed. Preferably, the duration of irradiation of the bias power Pb is set to fall in the range of 0.7T-2.5T, preferably 1.0T-2.0T.

When the irradiation duration becomes shorter than the foregoing, on the other hand, there tends to be caused recrystallization at the leading edge part of the recording mark by the irradiation of the next optical pulse of the peak power level Pb. When the duration exceeds the foregoing range, on the other hand, there is a possibility that the mark becomes discontinuous.

Further, because the difficulty of realizing a stationary temperature state in the case of forming a mark pattern after formation of the crystalline space region of the shortest 3T length is thus attributed ultimately to the insufficient cooling rate of the optical information recording medium 6, it is also effective to reduce the erasing power of the erasing optical beam to a level Pe′ lower than the erasing power Pe selectively at the time of forming the shortest crystalline space region of the 3T length (reference should be made to the broken line in FIG. 2). Thereby, the erasing power Pe is used for the case of forming the crystalline space region having the length of 4T or more.

Further, it is also effective to change the duration of irradiating the first optical pulse with the peak power level Pp selectively in the case of forming a recording mark after formation of the crystalline space region having the shortest mark length of 3T.

According to the investigation made by the inventor of the present invention with regard to the duration of the first optical pulse irradiated for formation of the amorphous mark pattern after formation of the crystalline space region of the 3T length, it was discovered that there is caused an improvement of jitter characteristics in the case the duration of the irradiation is increased over the case of irradiating the first optical pulse of the peak power level Pp after formation of the crystalline space region having the length 4T, while maintaining or decreasing the duration of irradiation of the first optical pulse of the peak power level in the case of forming an amorphous mark pattern after forming a crystalline space region of the length of 4T or more.

[Optical Information Recording Apparatus]

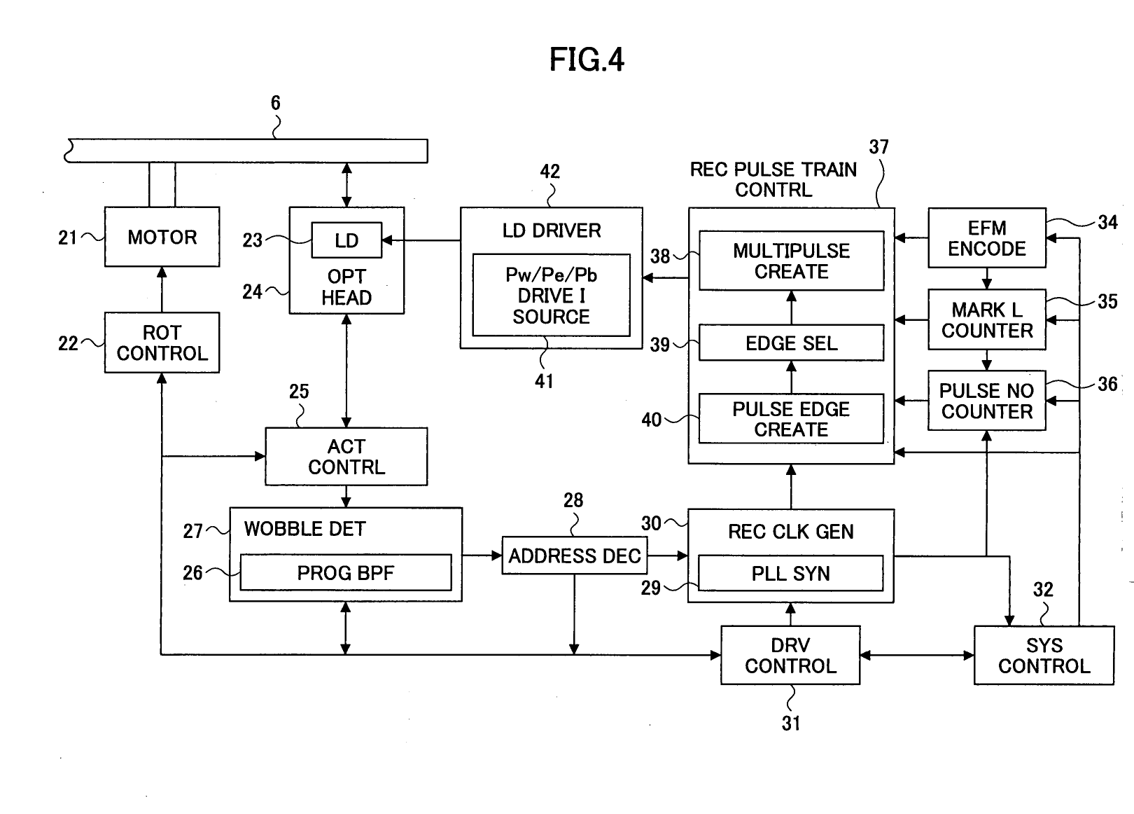

Next, explanation will be made on the construction of an optical information recording apparatus for realizing the optical information recording method that uses the recording strategy explained before with reference to FIG. 4.

Referring to FIG. 4, the optical information recording apparatus includes a rotation control mechanism 22 rotating an optical information recording medium 6 of DVD-RW specification via a spindle motor 21, and there is provided an optical head 24 including a laser diode LD 23 and an objective lens focusing a laser beam produced by the laser diode LD 23 upon the optical information recording medium 6 in such a manner that the optical head 23 is movable in the disk radial direction for seek operation.

As usual, an actuator control mechanism 24 is connected to the objective lens driving mechanism and the output system of the optical head 24, wherein a wobble detection part 27 including a programmable BPF 26 is connected to the actuator control mechanism 25 for detecting a wobble signal.

The wobble detection part 27 in turn is connected to an address decoding circuit 28, wherein the address decoding circuit 28 decodes the address from the wobble signal detected by the Wobble detection part 27, and the address decoding circuit 28 is connected with a recording clock generator 30 that includes a PLL synthesizer circuit 29. Further, a drive controller 31 is connected to the PLL synthesizer circuit 29.

It should be noted that the drive controller 31 is connected to the system controller 32, and the circuits such as the rotation control mechanism 22, the actuator control mechanism 24, the wobble detection part 27 and the address decoding circuit 28 are also connected to this drive controller 31.

The system controller 32 includes a CPU, and the like, and may be provided in the form of a microcomputer, wherein the system controller 32 is connected with the parts such as an EFM encoder 34, a mark length counter 35, and a pulse number controller 35, and a recording pulse train control part 37 is connected to the EFM encoder 34, the mark length counter 35, the pulse number control part 35 and the system controller 17 as an optical emission waveform control means. It should be noted that this recording pulse train control part 37 includes a multi-pulse creation part 38 creating the plural pulses (on-pulse for peak power Pp, off-pulse for bias power Pb) prescribed by the recording strategy, an edge selector 39 and a pulse edge creation part 40.

To the output side of the recording pulse train control part 37, there is connected a LD driver part 42 used as an optical source driving means driving the laser diode 23 in the optical head 24 by switching the respective drive current sources 41 of the recording power Pw (peak power Pp), erasing power Pe and a bias power Pb.

In order to achieve optical recording on the optical information recording medium 6 in such a construction, the rotational speed of the spindle motor 21 is controlled by using the rotation control mechanism 22 under the control of the drive controller 31 such that a predetermined linear recording velocity is attained, and decoding of the address is made from the wobble signal separated from the push-pull output signal of the optical head 24 by the programmable BPF. Further, a recording channel clock is created by using the PLL synthesizer circuit 29.

Next, in order to generate the recording pulse train used by the laser diode 23, a recoding channel clock and EFM+ data, which constitutes the recording information, are supplied to the recording pulse train controller 37, and the plural pulses shown in FIG. 2 are created according to the recording strategy by the multi-pulse generator 38 in the recording pulse train controller 37. Thereby, by switching the drive current sources 41 set respectively to the foregoing power levels Pw, Pe and Pb by using the LD driver part 42, the optical emission waveform is obtained in conformity with the recording pulse train.

Further, in the recording pulse train controller 37 of the present embodiment, the mark length counter 36 is provided for counting the mark length of the EFM+ signal obtained from the EFM encoder 34, and each time the mark count value increases by 2T, the pulse number control part 36 creases a pulse set (on-pulse of the recording power Pw (peak power Pp) and an off-pulse of the bias power Pb). With this, the plural pulses are created.

Alternatively, the multi-pulse creation part may have the construction of: forming a frequency-divided recording clock by dividing the frequency of the recording channel clock by two; creating edge pulses from the frequency-divided recording clock by using a multiple-stage delay circuit; and creating the foregoing pulse set (on-pulse of the recording power Pw (peak power Pb) and off-pulse of bias power Pb) each time there occurs an increase of 2T in the recording channel clock by selecting the front and rear edge pulses. In this latter construction, the actual operational frequency of the multi-pulse creation part becomes ½ and it becomes possible to carry out a further higher recording operation.

Hereinafter, examples of the foregoing embodiment will be explained.

### EXAMPLE 1

FIG. 2 shows the optical emission waveform pattern of Example 1.

Referring to FIG. 2, Example 1 uses the recording strategy of using the erasing power level Pe during the formation of the crystalline space region and reduces the optical power to the bottom power level Pb at the time of transition to the state formation of the recording mark.

In Example 1, the optical information recording medium 6 is constructed on a disk-shaped polycarbonate substrate having a diameter of 12 cm and a thickness of 0.6 mm and formed with guide grooves with the track pitch of 0.74 μm, wherein the polycarbonate substrate is covered with the first protective layer 2 of ZnS—SiO₂ with a thickness of 60 nm, and the recording layer 3 of In—Sb—Ge is formed on the first protective layer 2 with the thickness of 15 nm. Further, the second protective layer 4 of ZnS—SiO2 is formed on the recording layer 3 with a thickness of 12 nm, and the sulfuration prevention layer 7 of SiC is formed on the second protective layer 4 with the thickness of 4 nm. Further, the reflective layer 5 of Ag is formed on the sulfuration prevention layer 7 with a thickness of 140 nm. Thereby, the layers 2, 3, 4, and 5 are formed consecutively by a sputtering process, and the reflection layer 5 is covered with the overcoat of the organic protective layer 8.

Further, a polycarbonate disk of the 0.6 mm thickness is bonded on such a layered structure. The optical information recording medium 6 thus formed is subsequently subjected to initializing crystallization process by using a large diameter laser beam.

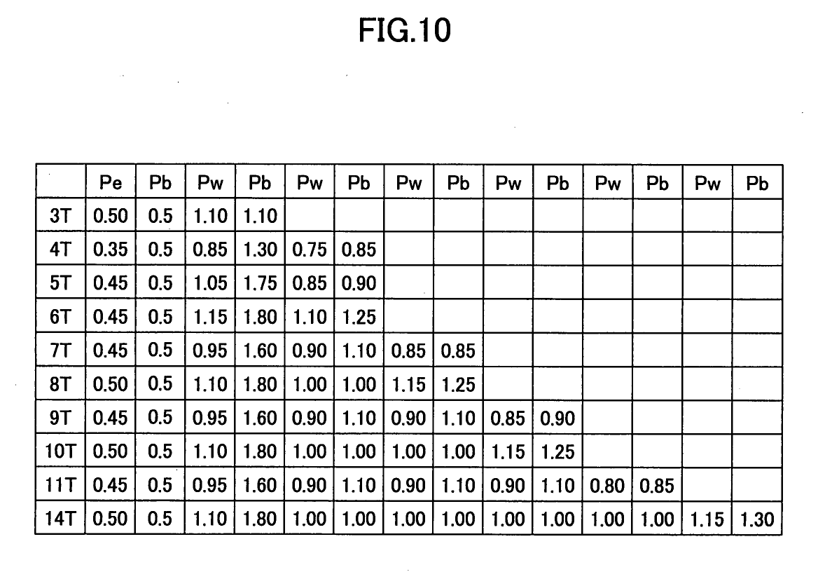

FIG. 10 shows an example of the recording strategy for each mark length in the case a random pattern having the recording bit length of 0.267 μm/bit is recorded on the optical information recording disk noted above by using the EFM+ modulation method with the eightfold recording speed of DVD of 28 m/s, while using the optical head 24 of the 660 nm wavelength and the numerical aperture NA of 0.65.

Referring to Table 1, the duration for holding the laser power as measured from the starting point of the recording mark is represented in the form normalized by the reference clock period T.

Thus, in the illustrated example, there is provided an interval of irradiating the optical disk with the bias power level Pb at the head part of each recording mark with the duration of 0.5T, irrespective of the length of the crystalline space region immediately preceding the recording mark. Thereby, it should be noted that the power levels are set to: Pw (=Pp)=26 mW; Pb=0.1 mW; Pe=9 mW.

After carrying out repetitive recording for ten times, it was confirmed that the overall jitter of the mark edge with respect to the clock takes the value of 9.2%.

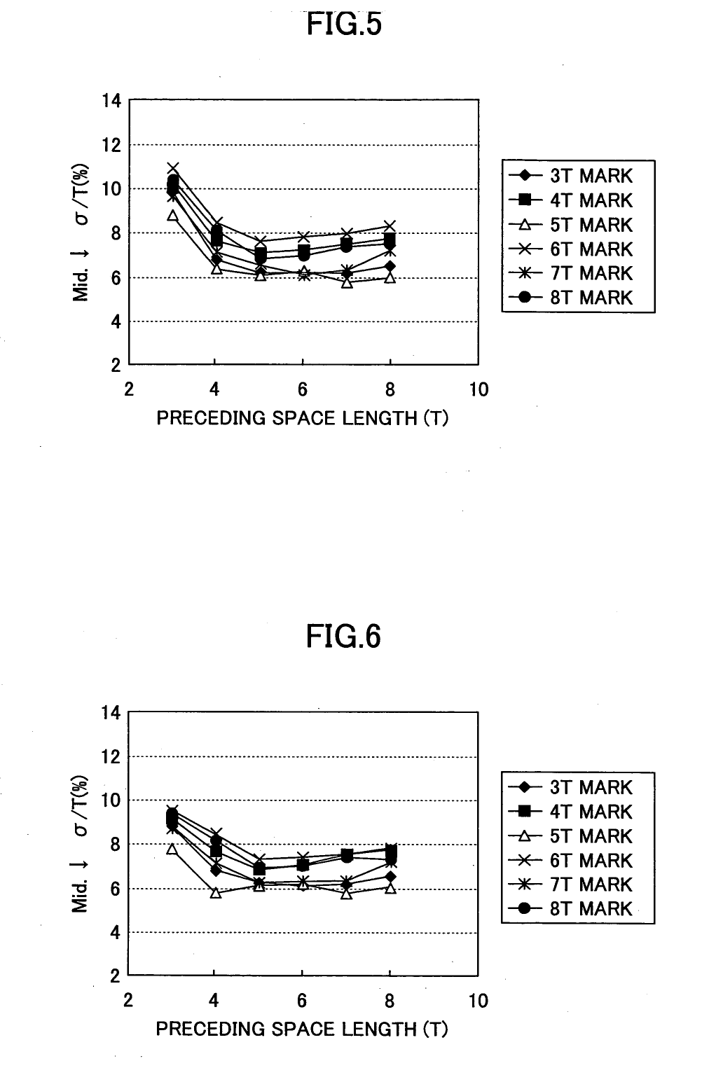

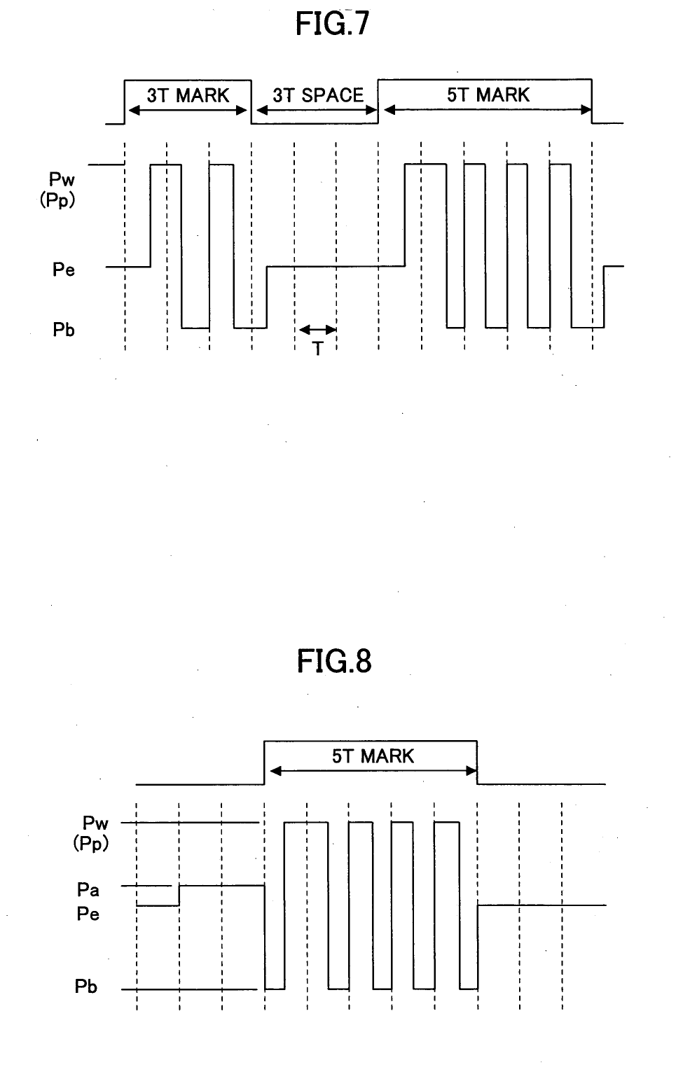

FIG. 5 shows the details of the jitter at the mark leading edge formed after the crystalline space region of various lengths.

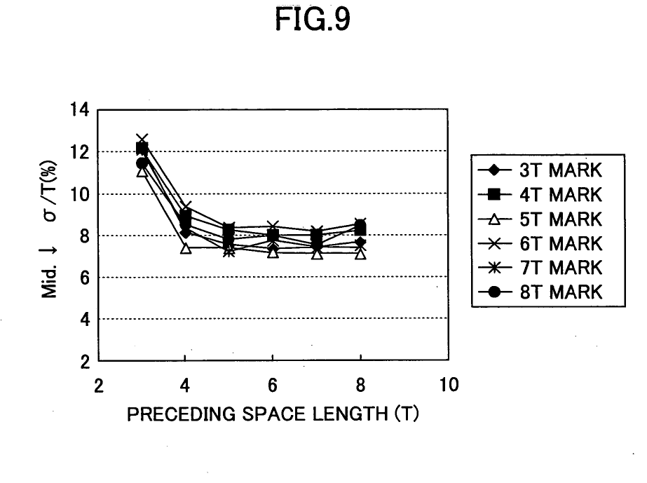

Referring to FIG. 5, it can be seen that the jitter is clearly improved as compared with the case of FIG. 9, although FIG. 5 shows the tendency that there still occurs increase of jitter when the mark pattern is formed after the shortest 3T space region.

### EXAMPLE 2

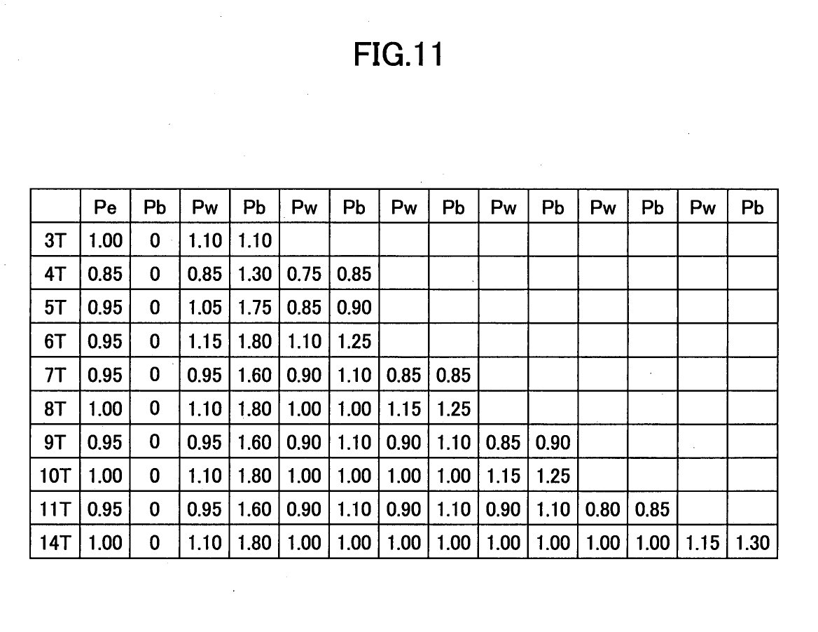

In Example 2, the same optical information recording medium 6 of Example 1 is used, and recording is carried out according to the strategy shown in FIG. 11 in which it will be noted that the same recording strategy as in the case of FIG. 10 is used in the case of forming a mark pattern after formation of the 3T space region of the shortest length. Otherwise, the no such a modulation of the optical beam power to the bottom power level Pb is made. Thus, the in the case of forming a mark pattern after forming a space region of the 4T or more in the length, there is caused no decrease of the optical beam power after using the erasing optical power Pe. The setting of the various optical power levels is the same also in Example 2.

After carrying out repetitive recording for ten times, it was confirmed that the overall jitter of the mark edge with respect to the clock takes the value of 9.6%.

Detailed investigation on the jitter at the mark leading edge formed after the crystalline space region of various lengths revealed the relationship similar to the one shown in FIG. 5.

Thus, the jitter is clearly improved as compared with the case of FIG. 9, although there still remains the tendency that there occurs an increase of jitter when the mark pattern is formed after the shortest 3T space region.

### EXAMPLE 3

In Example 3, recording is carried out on an optical recording medium identical with the optical recording medium 6 used in Example 1 while using the recording strategy shown in Table 1, except that the erasing power Pe is reduced to an erasing power Pe′ of 8 mW at the time of forming the shortest space region of the 3T length. Otherwise, Example 3 is identical with Example 1.

After carrying out repetitive recording for ten times, it was confirmed that the overall jitter of the mark edge with respect to the clock takes the value of 9.0%.

Detailed investigation on the jitter at the mark leading edge formed after the crystalline space region of various lengths revealed the relationship similar to the one shown in FIG. 5.

Thus, the jitter is clearly improved as compared with the case of FIG. 9, although there still remains the tendency that there occurs an increase of jitter when the mark pattern is formed after the shortest 3T space region.

### EXAMPLE 4

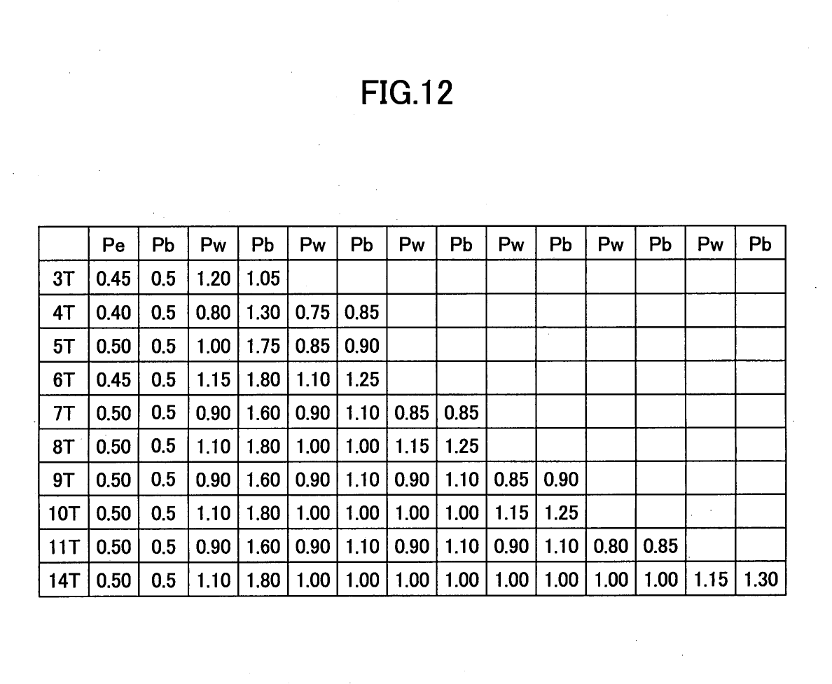

In Example 4, recording is made to the optical information recording medium 6 identical to that used in Example 1, wherein Example 4 uses the recording strategy of FIG. 12 in the case of forming a mark pattern after the shortest space region of the 3T length. On the other hand, Example 4 uses the recording strategy of FIG. 10 in the case of forming a mark pattern after the crystalline space region of the length of 4T or more. Thus, the duration of the peak power level Pp of the first optical pulse is increased (1.10→1.20) only after the 3T space region and is decreased (0.85→0.80, 1.05→1.00) after the space pattern of 4T or 5T.

After carrying out repetitive recording for ten times, it was confirmed that the overall jitter of the mark edge with respect to the clock takes the value of 8.8%.

FIG. 6 shows the result of detailed investigation of the jitter at the mark leading edge formed after the crystalline space region of various lengths.

According to the result of FIG. 6, the jitter is clearly improved as compared with the case of FIG. 9, although there still remains the tendency that there occurs an increase of jitter when the mark pattern is formed after the shortest 3T space region.

Further, the present invention is by no means limited to the embodiments described heretofore, but various variations and modifications may be made without departing from the scope of the invention.

1. An optical information recording method for recording information on an optical information recording medium by a mark length recording method according to a recording strategy in which a recording mark is formed on said optical information recording method with a mark length corresponding to a duration nT (n: integer; T: fundamental clock period), said recording strategy comprising the steps of:
forming a mark pattern of amorphous state having a mark length corresponding to a duration nT in a recording layer of said optical information recording medium by irradiating a surface of said optical information recording medium with an optical beam in the form of plural optical pulses with an integer number equal to or less than n/2, said optical pulses including a repetition of a peak power optical pulse having a first, relatively high optical power, and a bias optical pulse having a second, relatively low optical power; and
forming a space region of crystalline state having a space length corresponding to a duration nT adjacent to said amorphous mark pattern by irradiating said surface of said optical information recording medium with said optical beam as an erasing optical beam with an intermediate optical power intermediate of said first optical power and said second optical power,
wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

2. The optical information recording method as claimed in claim 1, wherein said crystalline space region of shortest length has a length corresponding to duration 3T.

3. The optical information recording method as claimed in claim 1, wherein said optical beam is reduced to said low power level at the time of transition from said step of forming said crystalline space region to said state of forming said amorphous recording mark pattern, irrespective of said length of said crystalline space region.

4. The optical information recording method as claimed in claim 1, wherein said low power level of said optical beam set equal to a bias optical power.

5. The optical information recording method as claimed in claim 1, wherein the duration in which said optical power of said optical beam is reduced to said low power level is set shorter than said fundamental clock period T.

6. The optical information recording method as claimed in claim 1, wherein a power level of said erasing optical beam used for forming said crystalline space region of shortest length is set to be lower than a power level of said erasing optical beam used at the time of forming a longer crystalline space region.

7. The optical information recording method as claimed in claim 1, wherein the duration of optical irradiation of the first optical pulse of said plural optical pulses irradiated for forming said amorphous mark pattern with said first optical power after said shortest crystalline space region is made different with regard to the duration of optical irradiation of the first optical pulse of said plural optical pulses irradiated for forming said amorphous mark pattern with said first optical power after a crystalline space region or longer length.

8. The optical information recording method as claimed in claim 1, wherein said optical information recording medium is an optical information recording medium of a phase change type.

9. The optical information recording method as claimed in claim 8, wherein said optical information recording medium of phase change type comprises a lamination of at least a first protective layer, a recording layer, a second protective layer and a reflective layer formed on a substrate, and wherein said recording layer contains Sb and one or more elements selected from the group consisting of Ge, Ga, In, Zn, Mn, Sn, Ag, Mg, Ca, Ag, Bi, Se and Te.

10. The optical information recording method as claimed in claim 9, wherein said recording medium contains Sb with a concentration of 50-90 atomic %.

11. The optical information recording method as claimed in claim 9, wherein said reflection layer comprises Ag or an Ag alloy.

12. The optical information recording method as claimed in claim 9, wherein said first protective layer and said second protective layer comprises a mixture of ZnS and SiO₂.

13. The optical information recording method as claimed in claim 9, wherein there is further provided a sulfuration prevention layer between said second protective layer and said reflection layer.

14. The optical information recording method as claimed in claim 13, wherein said sulfuration prevention layer contains Si or SiC as a major component.

15. An optical information recording medium according to a mark length recording method, comprising:
a rotating mechanism rotating said optical information recording medium;
a laser source producing an optical beam such that said optical beam irradiates a surface of said optical information recording medium;
a driver circuit driving said laser source; and
an optical emission controller holding a recording strategy with regard to optical emission waveform of said optical beam produced by said laser source, said optical emission controller controlling said driver circuit according to said recording strategy,
said recording strategy comprising the steps of:
forming a mark pattern of amorphous state having a mark length corresponding to a duration nT (n: integer; T: period of a fundamental clock) in a recording layer of said optical information recording medium by irradiating said surface of said optical information recording medium with said optical beam in the form of plural optical pulses with an integer number equal to or smaller than n/2, said optical pulses including a repetition of a peak power optical pulse having a first, relatively high optical power and a bias optical pulse having a second, relatively low optical power; and
forming a space region of crystalline state having a space length corresponding to a duration nT in said recording layer adjacent to said amorphous mark pattern by irradiating said optical beam as an erasing optical beam with an intermediate optical power intermediate of said first optical power and said second optical power,
wherein transition from said step of forming said space region to said step of forming said mark pattern is achieved by modulating said optical beam such that an optical power of said optical beam is reduced once to a low power level lower than said intermediate optical power of said erasing optical beam at least in the case of transition from said step of forming said space region having the shortest length to said step of forming said mark pattern.

16. The optical information recording apparatus as claimed in claim 15, wherein said optical emission controller controls said driver circuit such that said crystalline space region of shortest length has a length corresponding to duration 3T.

17. The optical information recording apparatus as claimed in claim 15, wherein said optical emission controller controls said driver circuit such that said optical beam is reduced to said low power level at the time of transition from said step of forming said crystalline space region to said state of forming said amorphous recording mark pattern, irrespective of said length of said crystalline space region.

18. The optical information recording apparatus as claimed in claim 15, wherein said optical emission controller controls said driver circuit such that said low power level of said optical beam set equal to a bias optical power.

19. The optical information recording apparatus as claimed in claim 15, wherein said optical emission controller controls said driver circuit such that the duration in which said optical power of said optical beam is reduced to said low power level is set shorter than said fundamental clock period T.

20. The optical information recording apparatus as claimed in claim 15, wherein said optical emission controller controls said driver circuit such that a power level of said erasing optical beam used for forming said crystalline space region of shortest length is set to be lower than a power level of said erasing optical beam used at the time of forming a longer crystalline space region.

21. The optical information recording apparatus as claimed n claim 15, wherein said optical emission controller controls said driver circuit such that the duration of optical irradiation of the first optical pulse of said plural optical pulses irradiated for forming said amorphous mark pattern with said first optical power after said shortest crystalline space region is made different with regard to the duration of optical irradiation of the first optical pulse of said plural optical pulses irradiated for forming said amorphous mark pattern with said first optical power after a crystalline space region or longer length.

22. The optical information recording apparatus as claimed in claim 15, wherein said optical information recording medium is an optical information recording medium of a phase change type.
